(19) United States
(12) Patent Application Publication
(10) Pub. No.: US 2025/0292678 A1
(43) Pub. Date: Sep. 18, 2025

(54) METHOD FOR SENDING VEHICLE-TO-X-MESSAGES, METHOD FOR DETERMINING A POSSIBLE COLLISION, AND VEHICLE-TO-X-COMMUNICATIONS MODULE

(71) Applicant: Continental Automotive Technologies GmbH, Hannover (DE)

(72) Inventors: Khalilullah Akber, Wetzlar (DE); Attila Jaeger, Gersfeld (DE)

(73) Assignee: Continental Automotive Technologies GmbH, Hannover (DE)

(21) Appl. No.: 18/860,490

(22) PCT Filed: Mar. 14, 2023
(86) PCT No.: PCT/EP2023/056419

§ 371 Date: Oct. 25, 2024

(30) Foreign Application Priority Data
Apr. 27, 2022 (DE) 10 2022 204 063.5

(51) Int. Cl. G08G 1/09; G08G 1/01; H04W 4/40

(52) U.S. Cl. CPC G08G 1/092; G08G 1/0112; H04W 4/40

(57) ABSTRACT

A of performing vehicle-to-everything (V2X) communication based on identification value of a road on which a vehicle is driving. The identification value of the road may be utilized to determine whether the road intersects with another road. If the road intersects with another road, then a possible collision between vehicles located at a same geographic position may occur. If the road does not intersect with another road, but passes over or under the road, then no possible collision exists between vehicles located at a same geographic position.

### CROSS-REFERENCE TO RELATED APPLICATIONS

The present application is a National Stage Application under 35 U.S.C. § 371 of International Application No. PCT/EP2023/056419 filed on Mar. 14, 2023, and claims priority from German Patent Application No. 102022204063.5 filed on Apr. 27, 2022, in the German Patent and Trade Mark Office, the disclosures of which are herein incorporated by reference in their entireties.

### BACKGROUND

### 1. Field

Embodiments of the present application relate to a method for sending vehicle-to-X-messages at a vehicle, to a method for determining a possible collision between a vehicle and a further vehicle, and to a corresponding vehicle-to-X-communications module.

### 2. Description of Related Art

Vehicle-to-X-communication is a powerful tool in order to inform vehicles and infrastructure units about vehicle movements and other traffic conditions, in order to prevent accidents. However, the likelihood of a possible collision between two vehicles driving on different intersecting roads not only depends on their current position, direction, and velocity, but also on the type of crossing, i.e., if the two roads have a common crossover, or if one road has a bridge over the other road. In the former case, a collision is possible. In the latter case, a collision is physically impossible. In principle, a discrimination between the two cases can be made by evaluating information about respective altitudes of the vehicles. However, there are some countries in which sending of such altitudes is not permitted.

### SUMMARY

Aspects and objects of embodiments of the present application provide for methods that can enable functionality derived from vehicle-to-X-communication that is better or alternative to known solutions. Aspects and objects of embodiments of the present application provide for a corresponding vehicle-to-X-communications module. This is achieved by respective methods according to the respective main claims and by a vehicle-to-X-communications module according to the corresponding main claim. Preferred embodiments can, for example, be derived from the respective dependent claims. The content of the claims is made a content of the description by explicit reference.

According to an aspect of an embodiment, there is provided a method for sending vehicle-to-X-messages at a vehicle. The method comprises the following steps:
determining a road on which the vehicle is driving,
determining an identification value based on the road, and
sending at least some of the vehicle-to-X-messages such that they include the identification value.

Such a method allows an indication of a road to be included in vehicle-to-X-messages, so that other vehicles or infrastructure units can identify on which road the sending vehicle is driving. This can be used in order to determine if two vehicles are driving on roads that intersect at a cross-section, or using a bridge. In the latter case, it can be readily determined that no collision is possible at all. There is no need to send altitude information using vehicle-to-X-messages.

The method can especially be performed at a vehicle driving on a road. Especially, it can be implemented in a vehicle-to-X-communications module being present in the vehicle. The road can, for example, be determined using satellite navigation and/or terrestrial navigation and/or an electronic map. The road is typically a usual road intended for public transport, for example a highway or a smaller road inside or outside of urban areas.

The identification value can especially be a unique identifier for the road. Especially, there can be a set of possible identifiers, each identifier uniquely identifying one road. Thus, it can be readily determined using electronic maps or other means if two roads intersect and if a collision is possible at all.

According to an aspect of an embodiment, there is provided a method for determining a possible collision between a vehicle and a further vehicle, wherein the method comprises the following steps:
determining a road on which the vehicle is driving,
determining an identification value based on the road,
receiving a vehicle-to-X-message comprising a further identification value relating to the further vehicle, and
determining a possible collision only if the identification value corresponds to the further identification value.

This method allows for determining a possible collision or a possibility of a collision without the need of altitude information regarding the respective vehicles. It is sufficient to determine a road on which the vehicle is driving and to determine the road on which another vehicle is driving in order to determine if a collision is possible at all.

Especially, it may be implemented that the identification value corresponds to the further identification value if, and only if, the identification value identifies the same road as the further identification value or if the identification value identifies a road intersecting a road identified by the further identification value at a cross-section. This means that the identification value corresponds to the further identification value only if a collision is physically possible.

The road on which the vehicle is driving may especially be determined using satellite navigation and/or terrestrial navigation and/or an electronic map. This allows a secure determination of a road. The identification value can especially be taken from a defined set of identification values from which also the further identification value is taken.

The determining of a possible collision can especially mean that it is determined if a collision is possible, or to determine a probability of the collision. For example, other factors like intended course or other traffic conditions can be taken into account. An identification value corresponding to the further identification value can especially mean that the two identification values indicate that the two vehicles are driving on roads intersecting at a cross-section. Especially, the identification value not corresponding to the further identification value can mean that the two vehicles are driving on roads intersecting using a bridge, or not intersecting at all. However, also other definitions can be used.

A possible collision can especially be determined based on the predicted common place based on motion data of the vehicle and the further vehicle. Motion data of the vehicle can especially be based on vehicle sensors and/or satellite navigation and/or terrestrial navigation. Motion data of the further vehicle can especially be based on information contained in the received vehicle-to-X-message and/or other vehicle-to-X-messages. A predicted common place can be a common place in a two-dimensional coordinate system, especially being irrespective of an altitude. A common place could be a place at which the two vehicles can collide if they are on the same altitude. However, it is clear that the two vehicles cannot collide if they are on different altitudes, for example because one of the vehicles drives over the other one using a bridge.

Preferably, the method can be performed responsive to a detection that the vehicle approaches an intersection or a bridge. At an intersection, a collision is in principle possible. If it is not clear if the vehicle approaches an intersection or a bridge, the method can be used in order to determine if a collision is possible.

According to an aspect of an embodiment, there is provided a vehicle-to-X-communications module being configured to perform a method as disclosed herein. According to an aspect of an embodiment, there is provided a non-transitory computer-readable medium comprising program code that causes a processor to perform a method as disclosed herein. With regard to the method, all embodiments and variations as disclosed herein can be applied.

In general, vehicle communication provides the technology to exchange messages containing position, speed, and other relevant data between vehicles. Based on these messages, multiple traffic safety related applications can be realized. For example, an intersection movement assist application predicts possible collision at the intersection, based on own vehicle data and received vehicle-to-X-messages.

It can warn a driver accordingly. Basic safety messages can be sent periodically by vehicles and can contain information about the position, speed, and other relevant vehicle data. MAP messages can contain information about the trajectory of a road and lanes, possible connections, and other information.

Intersection movement assist can predict incorrect collision in areas or countries where elevation information of vehicle-to-X-messages is not allowed to be transmitted. In the absence of elevation, it is not possible to differentiate between an intersection and flyover (over-bridge or under-bridge) roads. Consequently, false positive warnings can be triggered regarding vehicles that are at a conflicting position but not at the same elevation and hence do not impede any threat.

The problem can be addressed using MAP data. A map matching algorithm may determine a Map Id of the map data, where the host vehicle (HV) and other vehicle-to-X enabled vehicles (received BSMs) are located. The vehicles (including HV) approaching to the same intersection matches to same Map Id. Therefore, only vehicles mapped to the same Map Id are considered to predict a collision risk at an intersection or other applications.

### BRIEF DESCRIPTION OF THE DRAWINGS

Aspects and object of embodiments of the present application will now be further explained with respect to the drawings, in which:

FIG. 1 is a diagram illustrating vehicle-to-X-communications according to an embodiment; and

FIG. 2 is a flowchart illustrating a method of performing vehicle-to-X-communications according to an embodiment.

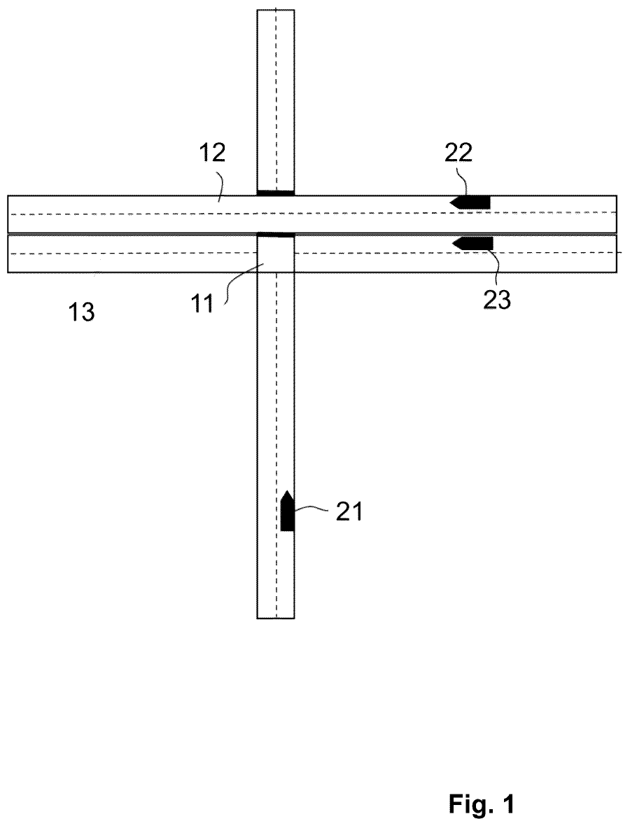

FIG. 1 shows a first road 11, a second road 12 and a third road 13 principally intersecting each other. The first road 11 and the third road 13 are on the same altitude and intersect at a cross-section. The second road 12 crosses the first road 11 on a bridge.

A first vehicle 21 drives on the first road 11. A second vehicle 22 drives on the second road 12. A third vehicle 23 drives on the third road 13. All three vehicles 21, 22, 23 drive towards intersection points of the three roads 11, 12, 13.

All vehicles 21, 22, 23 are capable of taking part in vehicle-to-X-communications, meaning that they can send vehicle-to-X-message and receive vehicle-to-X-messages in order to estimate a probability of collision. The sent vehicle-to-X-messages include a respective identification value corresponding to the specific road 11, 12, 13 on which the respective vehicle 21, 22, 23 is driving.

Based on map data, the vehicles are aware of the fact that only the first road 11 and the third road 13 intersect on the same level, wherein the second road 12 intersects over a bridge. Thus, it is determined that a collision between the second vehicle 22 and the other vehicles 21, 23 is physically not possible. However, a collision between the first vehicle 21 and the third vehicle 23 is possible and a corresponding probability can be determined based on motion data like current position, speed, or direction.

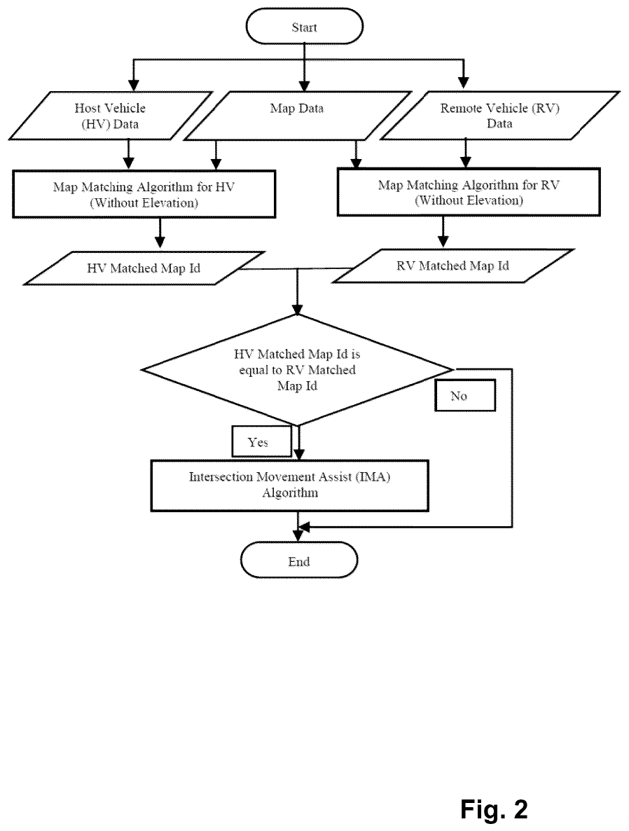

FIG. 2 shows a corresponding flow diagram. At a start point, data of a Host Vehicle (HV) and a Remote Vehicle (RV) are obtained. In addition, Map Data is obtained. In both vehicles, a Map Matching Algorithm (without elevation) is performed. Both algorithms yield a respective HV Matched Map Id which are compared to each other so as to determine if they are equal. If yes, an Intersection Movement Assist (IMA) Algorithm is performed. Such an algorithm can determine the probability of a collision. If not, the process will end immediately, as no collision is possible.

It should be pointed out in general that vehicle-to-X communication means, in particular, a direct communication between vehicles and/or between vehicles and infrastructure facilities and/or road users in general. By way of example, therefore, vehicle-to-vehicle communication or vehicle-to-infrastructure communication may be involved. Where communication between vehicles is referred to within the framework of this application, this can essentially, by way of example, take place within the framework of vehicle-to-vehicle communication, which typically takes place without the intermediary of a mobile network or a similar external infrastructure and which can therefore be distinguished from other solutions which, by way of example, are based on a mobile network. By way of example, vehicle-to-X communication can take place using the standards IEEE 802.11p or IEEE 1609.4. Vehicle-to-X communication can also be referred to as C2X communication. The sub-areas can be referred to as C2C (Car-to-Car) or C2I (Car-to-Infrastructure). Aspects of embodiments of the present application expressly do not, however, exclude vehicle-to-X communication with the intermediary of, for example, a mobile network.

Mentioned steps of the inventive method can be performed in the given order. However, they can also be performed in another order, as long as this is technically reasonable. The inventive method can, in an embodiment, for example with a certain combination of steps, be performed in such a way that no further steps are performed. However, also other steps may be performed, including steps that are not mentioned.

It is to be noted that features may be described in combination in the claims and in the description, for example in order to provide for better understandability, despite the fact that these features may be used or implemented independent from each other. The person skilled in the art will note that such features can be combined with other features or feature combinations independent from each other.

References in dependent claims may indicate preferred combinations of the respective features, but do not exclude other feature combinations.

1. A method of performing vehicle-to-everything (V2X) communication, the method comprising:
determining a road on which a vehicle is traveling;
determining an identification value associated with the road and
transmitting a V2X message from the vehicle to a recipient, the V2X message comprising the identification value associated with the road.

2. The method according to claim 1, wherein the identification value is a unique identifier of the road.

3. The method according to claim 2, wherein determining the identification value associated with the road comprises accessing at least one of satellite navigation, terrestrial navigation, and an electronic map.

4. A method of determining a possible collision between vehicles the method comprising:
determining a first road on which a first vehicle is traveling;
determining a first identification value associated with the first road;
receiving from a second vehicle a vehicle-to-everything (V2X) message, the V2X message comprising a second identification value associated with a second road on which the second vehicle is traveling; and
determining the possible collision between the first vehicle and the second vehicle based on the first identification value and the second identification value.

5. The method according to claim 4, wherein determining the possible collision comprises:
determining whether the first identification value matches the second identification value;
determining whether the first road associated with the first identification value intersects the second road associated with the second identification value; and
determining the possible collision based on a first result of determining that the first identification value matches the second identification value or a second result of determining that the first road intersects the second road.

6. The method according to claim 5, wherein the first road comprises accessing at least one of satellite navigation, terrestrial navigation, and an electronic map.

7. The method according to claim 6, wherein determining the possible collision comprises:
predicting a first position of the first vehicle based on first motion data of the first vehicle;
predicting a second position of the second vehicle based on second motion data of the second vehicle; and
determining the possible collision based on the first position and the second position.

8. The method according to claim 7, wherein predicting the first position and predicting the second position comprises accessing at least one of vehicle sensors, satellite navigation, and terrestrial navigation.

9. The method according to claim 8, wherein the V2X message comprises the second motion data.

10. The method according to claim 9, further comprising determining the first vehicle approaches an intersection or a bridge,
wherein determining the possible collision comprises determining the possible collision in response to determining the first vehicle approaches the intersection or the bridge.

11. (canceled)
